(19) United States
(12) Patent Application Publication
(10) Pub. No.: US 2026/0265092 A1
(43) Pub. Date: Sep. 10, 2026

(54) METHOD FOR RECYCLING SILICON IN WASTEWATER

(71) Applicant: SAMSUNG ELECTRONICS CO., LTD., Suwon-si (KR)

(72) Inventors: Jinhyeok JANG, Suwon-si (KR); Sung Bae KIM, Suwon-si (KR); Younghun KIM, Suwon-si (KR); Yunho KIM, Suwon-si (KR); Myungbeom PARK, Suwon-si (KR); Samjong CHOI, Suwon-si (KR); Jungwon KIM, Suwon-si (KR); Yigil CHO, Suwon-si (KR)

(73) Assignee: SAMSUNG ELECTRONICS CO., LTD., Suwon-si (KR)

(21) Appl. No.: 19/349,466

(22) Filed: Oct. 3, 2025

(30) Foreign Application Priority Data
Mar. 4, 2025 (KR) 10-2025-0027783

(51) Int. Cl. C02F 1/469; C01B 33/021; C02F 1/44; C02F 101/10; C02F 103/34

(52) U.S. Cl. CPC C02F 1/4696; C01B 33/021; C02F 1/444; C01P 2006/40; C02F 2101/10; C02F 2103/346

(57) ABSTRACT

A method is provided for recycling silicon from wastewater generated during semiconductor processing. The method includes coagulating silicon particles in the wastewater using a dielectrophoresis device to increase particle size, forming a silicon slurry with a microfiltration device, pressing the slurry to form a silicon cake, and drying the cake in a fluidized bed reactor to obtain silicon powder. The process enables efficient recovery of high-purity silicon using filters with relatively large pores, thereby reducing filter damage from heat generation and improving recovery yield. The recovered silicon powder may be further analyzed, purified of metal impurities, and recycled as a raw material for semiconductor wafers, silicon carbide power devices, or negative electrode materials for rechargeable batteries. This method provides both economic and environmental benefits by securing high-purity silicon materials from otherwise discarded wastewater.

### CROSS-REFERENCE TO RELATED APPLICATION

This application claims priority to and the benefit of Korean Patent Application No. 10-2025-0027783 filed with the Korean Intellectual Property Office on Mar. 4, 2025, the entire contents of which are incorporated herein by reference.

### BACKGROUND

### (a) Field

The present disclosure relates to a method for recycling silicon from wastewater.

### (b) Description of the Related Art

In a semiconductor manufacturing process, a Back Lap process is mainly a subsequent processing operation for silicon wafers, and is a work of polishing and trimming a back surface of the wafer. This process plays an important role in improving flatness of the wafer, adjusting a thickness of the wafer, or removing impurities before manufacturing an upper circuit layer.

In the Back Lap process, a large amount of wastewater is generated while polishing the wafer. This wastewater includes various chemicals along with silicon (Si) microparticles that fall off during the polishing process. A process of recovering silicon microparticles or excess silicon from wastewater is very important from both environmental and economic perspectives.

### SUMMARY

An aspect of the present disclosure attempts to provide a method for recycling silicon in wastewater, which includes coagulating silicon particles in wastewater using dielectrophoresis (DEP), and then separating the coagulated silicon particles from the wastewater to recover silicon, thereby having a high recovery rate even when a large-pore filter is used in a process of recovering the coagulated silicon particles.

Another aspect of the present disclosure attempts to provide a method for recycling silicon in wastewater, capable of ameliorating a problem of damage to a part of a filter due to heat generation that occurs when using a conventional filter with small pores, by using a filter with large pores.

An embodiment of the present disclosure provides a method for recycling silicon in wastewater including coagulating silicon particles in the wastewater using a dielectrophoresis device, forming a silicon powder using the coagulated silicon particles, and recovering the silicon powder.

Another embodiment of the present disclosure provides a method for recycling silicon in wastewater including coagulating silicon particles in the wastewater to a size of 100 nm or greater using a dielectrophoresis device, forming a silicon slurry from the wastewater using a microfiltration device, forming a silicon cake from the silicon slurry using a filter press, and forming the silicon powder by drying a silicon cake using a fluidized bed reactor.

Another embodiment of the present disclosure provides a method for recycling silicon in wastewater, including: coagulating silicon particles in the wastewater, forming a silicon powder using the coagulated silicon particles, analyzing a concentration of metal particles contained in the silicon powder, recovering the silicon powder, and recycling the recovered silicon powder.

According to an aspect of the present disclosure, it may be possible to provide a method for recycling silicon in wastewater with a high recovery rate even when using a large-sized filter, by coagulating silicon particles in wastewater using dielectrophoresis (DEP) technique and then separating the coagulated silicon particles to recover silicon.

According to another aspect of the present disclosure, it may be possible to provide a method for recycling silicon in wastewater, capable of ameliorating a problem of damage to a part of a filter due to heat generation that occurs when using a conventional filter with small pores, by using a filter with large pores.

### BRIEF DESCRIPTION OF THE DRAWINGS

FIG. 1 illustrates a flowchart for describing a method for recycling silicon in wastewater according to an embodiment.

FIG. 2 illustrates a view for describing a process of a method for recycling silicon in wastewater according to an embodiment.

FIG. 3 illustrates a dielectrophoresis device according to embodiments.

FIG. 4A illustrates a state in which wastewater containing silicon particles is accommodated in a chamber before dielectrophoresis is applied.

FIG. 4B illustrates a state in which an electric field is applied to the wastewater using electrodes, forming dipoles in silicon particles.

FIG. 4C illustrates a state in which the silicon particles have coagulated after a period of dielectrophoresis.

FIG. 5 illustrates a flowchart for describing a method for recycling silicon in wastewater according to another embodiment.

FIG. 6 illustrates a microfiltration device of FIG. 2.

FIG. 7 illustrates a view for describing a reason for growth of a size of silicon particles.

FIG. 8 illustrates a cross-sectional view of a filter press of FIG. 2.

FIG. 9 illustrates an enlarged view of a region “EX1” of FIG. 8.

FIG. 10 illustrates a cross-sectional view of a fluidized bed reactor of FIG. 2.

FIG. 11 and FIG. 12 each illustrate a flowchart for describing a method for recycling silicon in wastewater according to various embodiments.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

To clearly describe the present disclosure, parts that are irrelevant to the description in the drawings are omitted, and like numerals refer to like or similar constituent elements throughout the specification.

Further, since sizes and thicknesses of constituent members shown in the accompanying drawings are arbitrarily given for better understanding and ease of description. The present disclosure is not necessarily limited to what is illustrated. In the drawings, the size and thickness of layers, films, panels, regions, etc., are exaggerated for clarity. In the drawings, for better understanding and ease of description, the thicknesses of some layers and areas are exaggerated.

Throughout this specification and the claims that follow, when it is described that an element is “coupled/connected” to another element, the element may be “directly coupled/connected” to the other element or “indirectly coupled/connected” to the other element through a third element. In addition, unless explicitly described to the contrary, the word “comprise” and variations such as “comprises” or “comprising” will be understood to imply the inclusion of stated elements but not the exclusion of any other elements.

It will be understood that when an element such as a layer, film, region, plate, etc. is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

Further, throughout the specification, the phrase “in a plan view” means when an object portion is viewed from above, and the phrase “in a cross-sectional view” means when a cross-section taken by vertically cutting an object portion is viewed from the side.

In addition, throughout the specification, sequence numbers such as 1st, 2nd, etc. are used to distinguish a certain component from other components that are the same or similar thereto, and are not necessarily intended to refer to a specific component. Accordingly, a component referred to as a first component in a specific part of this specification may be referred to as a second component in other parts of this specification.

In addition, throughout the specification, singular references to certain elements include references to a plurality of these elements, unless specifically stated to the contrary. For example, “insulating layer” may be used to indicate not only one insulating layer but also a plurality of insulating layers, such as two, three, or more. Similarly, throughout the specification, components described in the plural may be implemented as singular components.

Additionally, throughout the specification, references to a first side and a second side are intended to distinguish different sides from each other, and are not necessarily intended to limit it to a specific side. Accordingly, a side referred to as a first side in a specific part of this specification may also be referred to as a second side in other parts of this specification.

Furthermore, throughout the specification, references to directions such as upper surface, upper side, upper portion, lower surface, lower side, lower portion, etc. are described to aid description and understanding based on the drawings.

Dielectrophoresis (DEP) is a technique that uses a force generated by non-uniformity of an electric field (non-uniform electric field) to move particles. This technique may also be applied to uncharged particles.

Dielectrophoresis occurs when particles are moved by a dielectrophoretic force generated in the non-uniform electric field (e.g., regions where the electric field gradually becomes stronger or weaker). If the electric field is non-uniform, even uncharged particles may move in response to the electric field.

In other words, dielectrophoresis refers to the phenomenon where a non-polar particle, when exposed to a non-uniform alternating electric field, has a dipole induced and experiences uneven electric forces depending on its surrounding environment, causing the particle to move or coagulate toward a region with a higher electric field gradient.

Electrophoresis (EP) is a technique that utilizes a phenomenon where charged particles or molecules move under an influence of an electric field, which occurs when a consistent electric field is applied. This is different from dielectrophoresis, which uses the force that occurs when the electric field is not uniform.

Dielectrophoresis is a technique primarily used to electrically separate microscale biological particles (such as cells). In materials such as CNT and graphene, where dipoles are easily induced, dielectrophoresis is prominently exhibited, resulting in a higher degree of particle alignment.

Furthermore, dielectrophoresis may achieve particle movement or coagulation effects even with the slight dipoles present in simple nanoparticles under an influence of voltage and electric fields (Ahn et al., Curr. Appl. Phys. 1, 143 (2005)).

Furthermore, it has been confirmed that dielectrophoresis may also be applied to the coagulation and separation of silicon (Si) nanoparticles, in addition to simple biological particles. When an alternating current is applied in a dual-electrode structure, dipoles are induced in silicon nanoparticles sized 0.5 to 1.3 nm, resulting in electrical coagulation. Accordingly, results of growth into large particles with a size of 141.8 to 295.3 nm were confirmed (Lee, Dongryul, et al. JACS Au 4.3 (2024): 1031-1038.).

In a silicon recycling method for wastewater according to the present disclosure, the process includes coagulating silicon particles, which are uncharged, during their movement using a non-uniform electric field.

Hereinafter, a method for recycling silicon in wastewater according to an embodiment of the present disclosure will be described in detail with reference to the drawings.

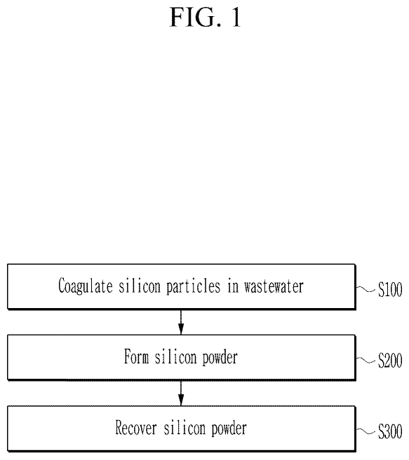

FIG. 1 illustrates a flowchart for describing a method for recycling silicon in wastewater according to an embodiment, and

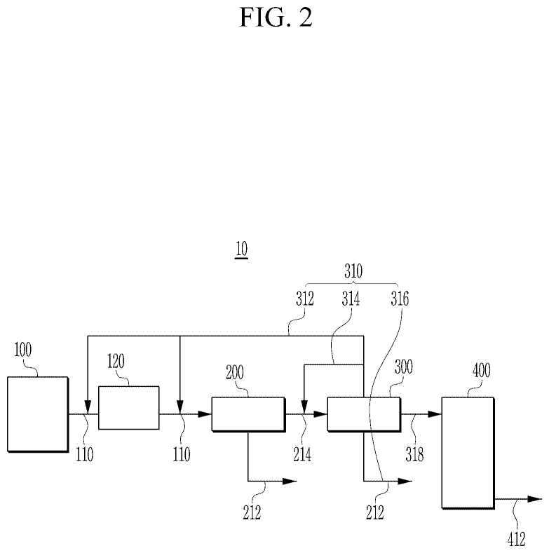

FIG. 2 illustrates a view for describing a process of a method for recycling silicon in wastewater according to an embodiment.

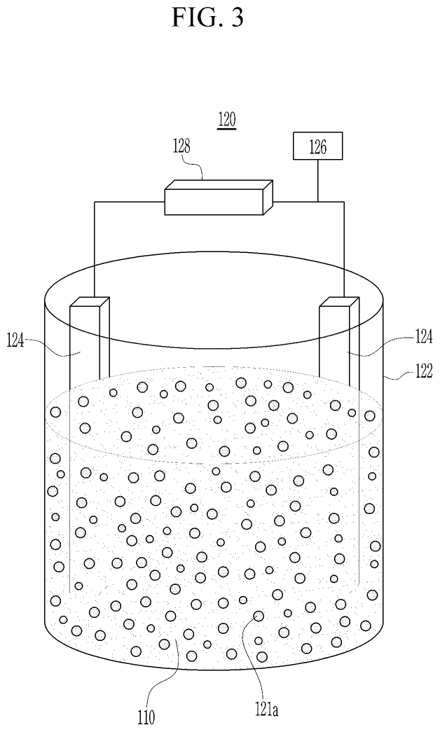

FIG. 2 illustrates a recycling apparatus 10 for silicon in wastewater in which a recycling method for silicon in wastewater is performed. FIG. 3 illustrates a dielectrophoresis device according to embodiments, and

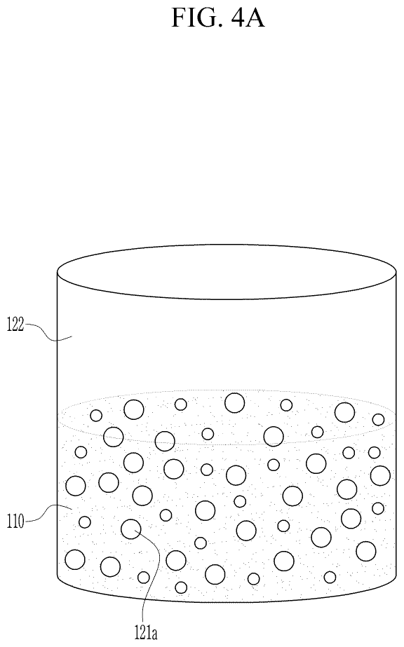

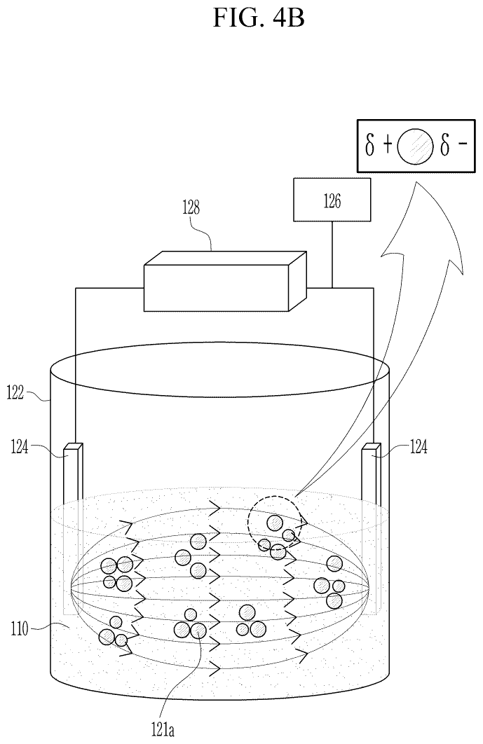

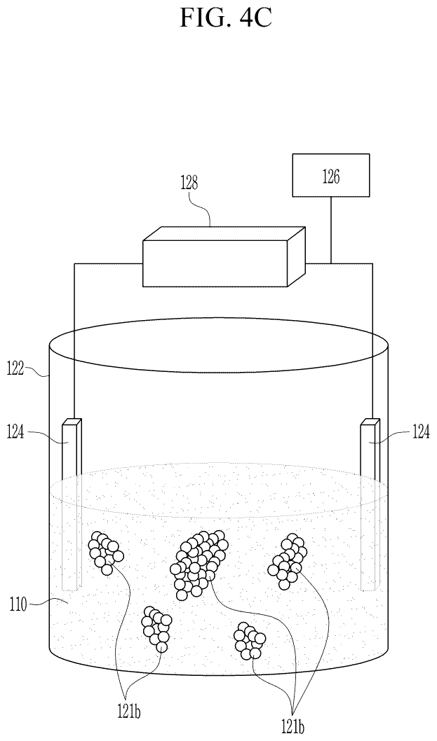

FIG. 4 illustrates a view for describing a coagulation process of silicon particles according to a dielectrophoresis device.

First, referring to FIGS. 1 to 4, the silicon recycling method for wastewater according to the present disclosure may include following operations: coagulating silicon particles 121a in wastewater 110 using a dielectrophoresis device 120 (Operation S100); forming a silicon powder 412 using the coagulated silicon particles 121b (Operation S200); and recovering the silicon powder (412) (Operation S300).

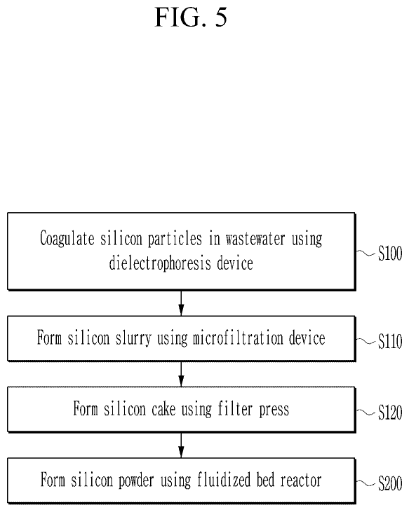

FIG. 5 illustrates a flowchart for describing a method for recycling silicon in wastewater according to another embodiment.

Referring to FIGS. 2 to 5, the silicon recycling method for wastewater according to the present disclosure may include following operations: coagulating silicon particles 121a in the wastewater 110 using the dielectrophoresis device 120 (Operation S100); forming a silicon slurry 214 from the wastewater 110 using a microfiltration device 200 (Operation S110); forming a silicon cake 318 from the silicon slurry 214 using a filter press 300 (Operation S120); and drying the silicon cake 318 using a fluidized bed reactor 400 to form the silicon powder 412 (Operation S200). Herein, the wastewater 110 may be delivered from wastewater tank 100.

As shown in FIG. 3, the dielectrophoresis device 120 may include a chamber 122 that holds the wastewater 110, electrodes 124 positioned within the wastewater 110, a power supply 126 that provides voltage to the electrodes 124, and a function generator 128 that adjusts the supplied voltage from the power supply 126 to create a non-uniform electric field.

The electrodes 124 are not limited to an arrangement position and a number shown in FIG. 3. The wastewater 110 illustrated in FIG. 3 may include silicon particles 121a before they are coagulated.

In dielectrophoresis (DEP), the electrodes 124, the power supply 126, and the function generator 128 may play an important role in inducing a dielectrophoretic effect and aligning or separating particles.

First, the electrodes 124 may form an electric field, and this electric field may act on the particles to move the particles in a specific direction. The electrodes 124 may receive a voltage to generate an electric field.

The electrodes 124 may be arranged in various ways. Generally, there are parallel electrode and interdigitated electrode (IDE) array configurations.

Parallel electrodes refer to electrodes arranged in parallel to create a uniform electric field, where intensity of the electric field may vary depending on a distance between the electrodes. Interdigitated electrodes refer to a configuration where multiple fine electrodes are arranged in an intersecting pattern, making this setup advantageous for controlling microparticles or cells.

A material used for the electrodes 124 may typically include a metal such as gold and platinum, or a semiconductor material. The material of the electrodes 124 may have to be selected considering electrical conductivity, chemical stability, and interactions with particles.

The function generator 128 may play a role in generating a non-uniform electric field by adjusting the voltage supplied from the power supply 126. In other words, the function generator 128 is a device that generates an electrical signal capable of adjusting a frequency, a waveform, and an amplitude.”The function generator 128 may be used to generate an alternating current (AC) signal to be applied to the electrodes 124, which cause a dielectrophoresis force to be applied to the particle, thereby generating a non-uniform electric field necessary to move the particle.

The power supply 126 may serve to supply an electrical signal, i.e., a voltage, to the electrodes 124, and may serve to transmit an electrical signal regulated by the function generator 128 to the electrodes 124. This signal may be mainly supplied as an alternating current (AC), and this current may generate an electric field through the electrodes 124.

FIG. 4A illustrates a state in which the wastewater 110 including silicon particles 121a is accommodated in the chamber 122. The silicon particles 121a are in a pre-coagulated state.

FIG. 4B shows a state in which the electrodes 124 are positioned in the wastewater 110, the power supply 126 and the function generator 128 are all connected to the electrodes 124, and an electric field is generated between the electrodes 124. As a non-uniform electric field is generated between the electrodes 124 in the wastewater 110 of FIG. 4B, a dipole may be formed in each of the silicon particles 121a. A phenomenon in which some of the silicon particles 121a in which the dipole is formed may occur.

FIG. 4C illustrates an image taken after a certain period of time has passed from FIG. 4B, and it may be confirmed that coagulated silicon particles 121b are included in the wastewater 110.

As shown in FIG. 4A to FIG. 4C, when a non-uniform electric field is generated in the wastewater 110, the dipole is formed in the silicon particles 121a in the wastewater 110, and after a certain period of time, it may be confirmed that the silicon particles 121b become coagulated with each other and grow in size.

Referring to FIG. 4A to FIG. 4C, Operation S100 of coagulating silicon particles 121a using a dielectrophoresis device 120 during the method for recycling silicon in the wastewater according to the present disclosure may be performed in a following order: an operation in which the dielectrophoresis device 120 generates an electric field in the wastewater 110; an operation in which a dipole is formed in the silicon particles 121a in the wastewater 110 (FIG. 4B); and an operation in which the silicon particles 121a with the formed dipole is coagulated with each other (FIG. 4C).

The dielectrophoresis device 120 may apply a non-uniform electric field, and a voltage applied by the dielectrophoresis device 120 may be within a range of 0 to 50 V. A frequency range generated by the dielectrophoresis device 120 may be from 0 to 1,000 kHz. A time for coagulating the silicon particles 121a using the dielectrophoresis device 120 may preferably be within 1 hour.

When using the dielectrophoresis device 120 coagulates the silicon particles 121a, a size of the silicon particles 121a included in the wastewater 110 supplied from the wastewater tank 100 may be increased by more than 100 times.

Specifically, the dielectrophoresis device 120 may aim to coagulate the silicon particles 121a, with a size of 1 to 10 nm, included in the wastewater tank 100, into silicon particles 121b with a size of 100 nm or greater.

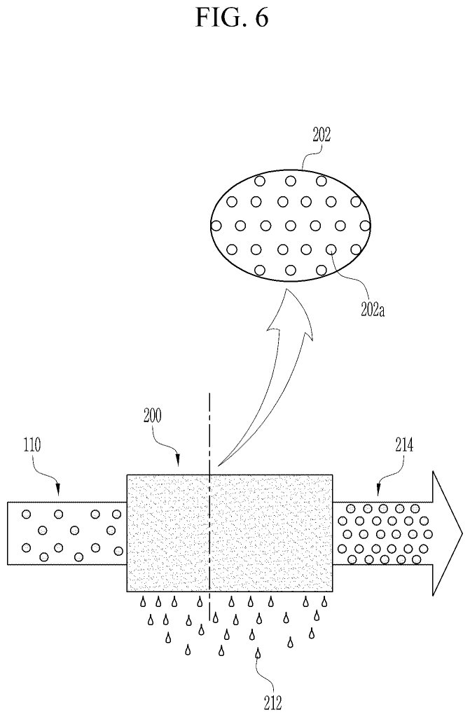

A reason for increasing the size of silicon particles 121a to that of silicon particles 121b will be described in detail below with reference to FIGS. 6 to 10.

Operation S200 of forming the silicon powder 412 using the coagulated silicon particles 121b may first include an operation of separating the coagulated silicon particles 121b from the wastewater 110.

In the operation of separating the coagulated silicon particles 121b from the wastewater 110, a microfilter 202 of the microfiltration device 200 may be used. That is, the microfilter 202 may filter out the coagulated silicon particles 121b in the wastewater 110 to form the silicon slurry 214 (S110).

Next, the operation for forming the silicon powder 412 may include Operation S120, which forms the silicon cake 318 from the silicon slurry 214 using the filter press 300, and Operation S200, which forms the silicon powder 412 from the silicon cake 318 using the fluidized bed reactor 400.

The method for recycling silicon in wastewater according to the present disclosure may aim to recover silicon from the wastewater 110 and recycle it, and the method may further include an operation of using the silicon powder 412 as a negative electrode material for rechargeable battery manufacturing and as a raw material for SiC power semiconductors, after forming the silicon powder 412.

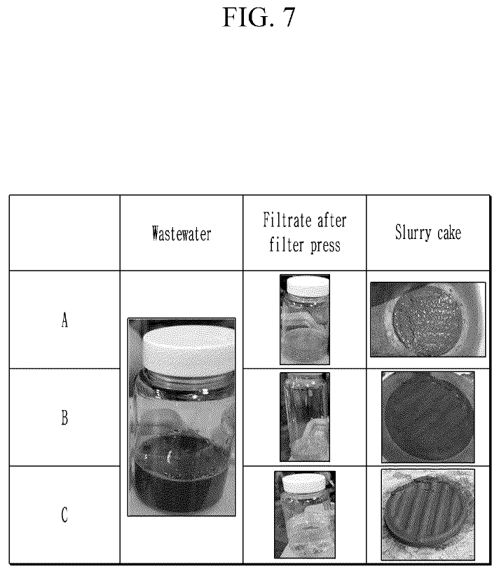

FIG. 6 illustrates the microfiltration device 200 of FIG. 2, and FIG. 7 illustrates a view for describing a reason for growing the size of the silicon particles 121a to a same size as that of the silicon particles 121b.

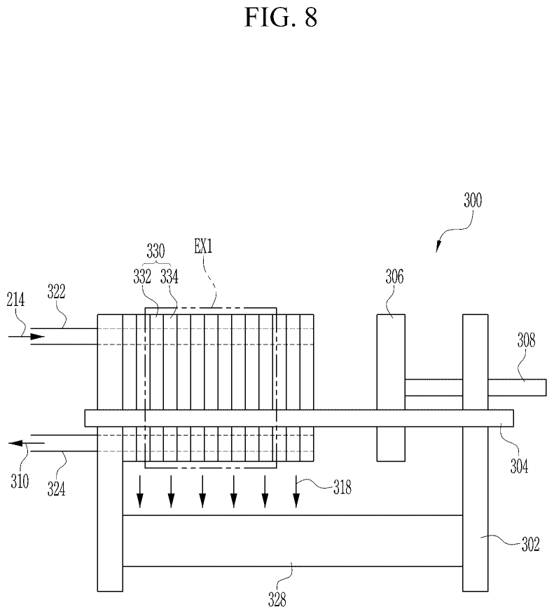

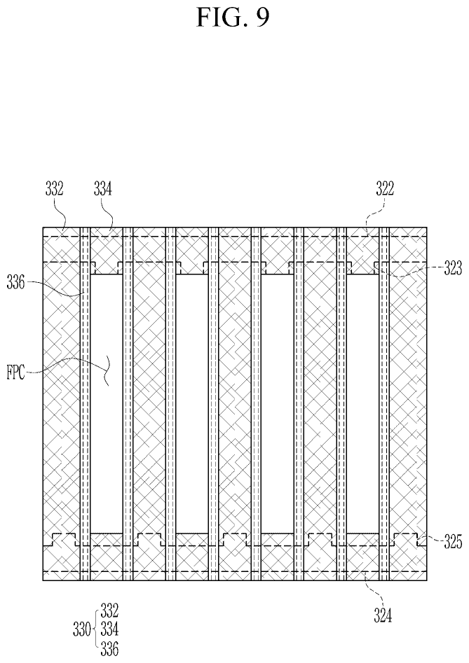

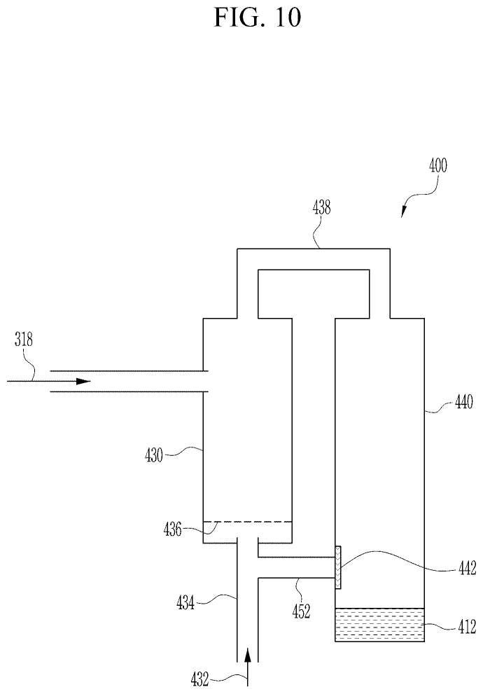

FIG. 8 illustrates a cross-sectional view of the filter press 300 of FIG. 2, FIG. 9 illustrates an enlarged view of a region “EX1” of FIG. 8, and FIG. 10 illustrates a cross-sectional view of the fluidized bed reactor 400 of FIG. 2.

Technical features of each operation of the method for recycling silicon in wastewater according to the present disclosure will be described in detail below with reference to FIGS. 2 to 10.

First, the silicon recycling method for wastewater according to embodiments of the present disclosure may include following operations: coagulating the silicon particles 121a having a size of 1 to 10 nm in the wastewater 110 to a size of 100 nm or more using the dielectrophoresis device 120 (Operation S100); forming a silicon slurry 214 from the wastewater 110 using a microfiltration device 200 (Operation S110); forming a silicon cake 318 from the silicon slurry 214 using a filter press 300 (Operation S120); and drying the silicon cake 318 using a fluidized bed reactor 400 to form the silicon powder 412 (Operation S200).

The Operation S100 of coagulating the silicon particles 121a having the size of 1 to 10 nm in the wastewater 110 to the size of 100 nm or more using the dielectrophoresis device 120 overlaps that described in FIGS. 1 to 4, and accordingly, a description thereof will be omitted.

A reason for causing silicon particles 121a to coagulate and grow like the silicon particles 121b will be described in detail below.

FIG. 6 illustrates an enlarged view of the microfiltration device 200 and the microfilter 202 included in the microfiltration device 200. Referring to FIG. 6, the Operation S110 of forming the silicon slurry 214 may utilize the microfilter 202 of the microfiltration device 200. The microfilter 202 may have a pore size of 100 nm to 1 μm in diameter.

Accordingly, the microfilter 202 may filter silicon particles 121b exceeding 100 nm to 1 μm in diameter. As a result, the silicon slurry 214 may be formed by using the silicon particles 121b that are larger than the pore of the microfilter 202, and thus may not pass through the pore.

As described above, if there is no process of forming the silicon particles 121b by coagulating the silicon particles 121a, the wastewater 110 moving to the microfiltration device 200 will include small-sized silicon particles 121a.

In such a case, if the pore size of the microfilter 202 is greater than 100 nm to 1 μm, it may become difficult to separate the small-sized silicon particles 121a from the wastewater 110. Accordingly, there is a problem of a low recovery rate of the silicon particles 121a.

In addition, assuming a case where a pore size of a filtration cloth 336 of the filter press 300 described in FIGS. 8 and 9 is set to approximately 1 μm and applied in two stages, there is a problem that heat is generated as a side reaction due to a strong pressure exerted on a filtration member 330 during a process of forming the silicon cake 318, causing partial damage to the filtration cloth 336.

If the pore size of the microfilter 202 or the pore size of the filtration cloth 336 of the filter press 300 is set to several hundred nm to 1 μm, there is a problem that the small silicon particles 121a of 100 nm or less may not be recovered.

If only small-sized silicon particles 121a are included in the wastewater 110 without going through a coagulation process, the problem occurs.

FIG. 7 illustrates for a view for describing differences in a filtration level of the wastewater 110 and a state of the slurry cake 318, which vary depending on pore sizes of the microfilter 202 and the filter press 300.

First, A indicates a case where the pore size of the microfilter 202 and the pore size of the filtration cloth 336 are greater than 100 nm to 1 μm, B indicates a case where the filtration cloth 336 of the filter press 300 is applied in one stage with the pore size of approximately 1 μm, and C indicates a case where the filtration cloth 336 of the filter press 300 is applied in two stages with the pore size of approximately 1 μm.

In Case A, when examining a state of filtrate after applying the filter press 200 to the wastewater 100, it may be observed that a separation degree of the silicon particles 121a in the wastewater 110 is very low. Additionally, it may be confirmed that a moisture removal rate is low and accordingly the slurry cake 318 is not formed.

In Case B, upon examining the filtrate, it may be confirmed that the separation degree of the silicon particles 121a in the wastewater 110 remains low, and a formation degree of the slurry cake 318 is also poor.

In Case C, upon examining the filtrate, it may be confirmed that the silicon particles 121a have been separated from the wastewater 110, and the formation degree of the slurry cake 318 is high. However, in the case of C, when high heat is generated during use of the filter press 300, a problem occurs where a portion of the filtration member 330 in addition to the filtration cloth 336 is damaged, making reuse impossible.

The method for recycling silicon in wastewater according to the present disclosure may aim to address the aforementioned issue by coagulating the silicon particles 121a in the wastewater 110 to grow them into silicon particles 121b and then utilizing the microfiltration device 200 and the filter press 300.

Accordingly, small silicon particles 121a of 100 nm or less may grow into silicon particles 121b of 100 nm or more, thereby ameliorating the conventional problem of not being able to recover small silicon particles 121a of 100 nm or less when using a filter with large pores.

That is, according to the present disclosure, even if the pore size of the microfilter 202 of the microfiltration device 200 is 100 nm to 1 μm, a yield of the silicon particles 121b may be increased.

In addition, there is an advantage in that, in the process of forming the silicon cake 318, a plurality of filtration cloths 336 may be used, both with pores of 100 nm to 1 μm in size and with pores of 1 μm to several thousand um in size. Accordingly, it may be possible to ameliorate the problem of damage to some of the filtration cloths 336 due to heat generation that occurred in the past.

Referring to FIGS. 8 and 9, the Operation S120 of forming the silicon cake 318 may be performed such that the silicon slurry 214 from the microfiltration device 200 passes through the filter press 300, thereby forming the silicon cake 318. Specifically, the silicon cake 318 may be formed by applying a pressure to the filtration member 330 of the filter press 300. As it passes through the filtration member 330, the silicon cake 318 and the filtrate 310 may be separated. The filtration member 330 of the filter press 300 may include a filtration plate 332, the filtration cloths 336, etc., which will be described below.

Referring to FIG. 10, the Operation S200 of forming the silicon powder 412 may involve drying the silicon cake 318 under a reducing atmosphere to produce the silicon powder 412. Specifically, the silicon cake 318 may be loaded into the fluidized bed reactor 400 and dried using a reducing gas to form the silicon powder 412.

In cases where certain embodiments are to be implemented differently, specific process sequences may be performed in a different order than described. For example, two processes described sequentially may be performed substantially simultaneously, or in the reverse order from that described.

The wastewater 110 in the present disclosure may be recovered from a semiconductor manufacturing process and stored in a wastewater tank 100 (see FIG. 2). According to embodiments, the semiconductor manufacturing process may include, e.g., a polishing process of a silicon wafer. For example, the semiconductor manufacturing process may include a back polishing (back lap) process to thin a thickness of a silicon wafer, a planarization process performed in the semiconductor manufacturing process, a dicing process, etc. However, the present disclosure is not limited to the examples described above, and various processes for discharging silicon-containing wastewater (110) may be included in the semiconductor manufacturing process.

In some embodiments, an operation of recovering the wastewater 110 may include an operation of uniformly spraying deionized water (hereinafter referred to as DI water) onto a polishing surface during the polishing process of a silicon wafer. Parts of the silicon wafer removed during the polishing process (hereinafter, silicon particles) may fly in a form of powder or dust. The silicon particles may be prevented from flying away by spraying DI water on the polishing surface, e.g., the surface in contact with a polishing pad, and the silicon particles may be dissolved in the DI water to be more easily recovered as waste water 110.

In some embodiments, the silicon particles may include a composite particle having a core (Si)-shell (SiO) structure in which a silicon core is coated with a silicon oxide film. In some embodiments, at least some of the silicon particles dispersed during the polishing process may react with DI water and air to form a SiO coating film on their surfaces. In this specification, “SiO” refers to a material including elements included in each term, and is not a chemical formula that represents a stoichiometric relationship.

In some embodiments, a thickness of the SiO coating film may be from 0.01 nm to 150 nm, but the present disclosure is not limited thereto. In some embodiments, a content of the composite particles having a core-shell structure with respect to a total weight of the silicon particles may be from about 0.01 wt % to 99.99 wt %, but the present disclosure is not limited thereto.

According to embodiments, the silicon slurry 214 may be formed from the wastewater 110 stored in the wastewater tank 100 using the microfiltration device 200. Specifically, the wastewater 110 stored in the wastewater tank 100 may pass through the dielectrophoresis device 120, and the wastewater 110 that has passed through the dielectrophoresis device 120 may then pass through the microfiltration device 200, forming the silicon slurry 214 (see FIG. 2).

Referring to FIG. 6, the microfiltration device 200 may be configured to separate a first filtrate 212 from the wastewater 110 to form the silicon slurry 214. According to embodiments, the microfiltration device 200 may include a microfilter 202 having a pore size of, e.g., about 100 nm to 1 μm.

The microfilter 202 may include a single-layer filter, a multi-layer filter with a stack structure, a membrane filter, or a fiber filter. In some embodiments, the microfilter (202) may include polytetrafluoroethylene (PVDF), fluorinated ethylene propylene (FEP), ethylene tetrafluoroethylene (ETFE), mixed cellulose esters (MCE), cellulose acetate (CA), or polytetrafluoroethylene (PTFE), the present disclosure is not limited thereto.

In some embodiments, the first filtrate 212 may include small particle size substances, such as moisture, ions, and fine particles, filtered from the wastewater 110 through the microfiltration device 200. In some embodiments, some of the moisture in the wastewater 110 may be removed into the first filtrate 212, so a content (wt %) of silicon particles in the silicon slurry 214 may be higher than the content (wt %) of silicon particles in the wastewater 110. In some embodiments, a content of silicon particles relative to a total weight of the silicon slurry 214 may be from about 2 wt % to about 35 wt %, but the present disclosure is not limited thereto.

In some embodiments, the first filtrate 212 may be transported to a purification module (not shown) and reused as process water through a reverse osmosis (RO) process, deionization process, etc.

Referring to FIGS. 8 and 9, according to embodiments, the silicon cake 318 may be formed from the silicon slurry 214 using the filter press 300 (S120). According to embodiments, the filter press 300 may be configured to separate and recover a second filtrate 310 from the silicon slurry 214 to form the silicon cake 318. In some embodiments, the second filtrate 310 may contain smaller particle size materials, such as moisture, ions, and fine sized particles, filtered from the silicon slurry 214 through the filter press 300.

According to embodiments, the filter press 300 may include a press body 302, a press rail 304, a plurality of filtration plates 332, a plurality of support frames 334, a plurality of filtration cloths 336, a pressure plate 306, and a pressure cylinder 308.

In some embodiments, the filtration plates 332 and the support frames 334 may be arranged alternately along a first horizontal direction (direction X) on the press rail 304. Additionally, the filtration cloths 336 may be positioned one at a time between each of the filtration plates 332 and the support frames 334. In some embodiments, the filtration plates 332, the support frames 334, and the filtration cloths 336 may constitute a filter structure.

Although FIG. 9 illustrates a vertical cross-section of the support frames 334, the support frames 334 may have a closed loop shape in a plan view. Referring to FIG. 9, the support frames 334 may each have a predetermined thickness in the first horizontal direction (direction X) to define an internal space. For example, both side walls of one support frame 334 along the first horizontal direction (direction X) may each be covered with the filtration cloths 336. Accordingly, a filtration chamber (FPC) may be defined by the filtration cloths 336 covering an inner wall of the support frame 334 and opposite side walls of the support frame 334. For example, a plurality of filtration chambers (FPC) may be positioned between each of the filtration plates 332.

In some embodiments, the filtration cloths 336 may be attached to opposite side walls of each of the filtration plates 332 along the first horizontal direction (direction X). In some other embodiments, the filtration cloths 336 may not be attached to each of the filtration plates 332, and may be spaced apart from the filtration plates 332 when the filter press 300 is not in operation, but may come into contact with each of the filtration plates 332 when pressed by the pressure plate 306. In some embodiments, the pressure plate 306 may be configured to move in the first horizontal direction (direction X) via the pressure cylinder 308 and pressurize the filter structure in the first horizontal direction (direction X). For example, the pressure cylinder 308 may include, but is not limited to, a hydraulic cylinder or a gas cylinder, and various means may be adopted to apply pressure to the filter structure by moving the pressure plate 306 toward the filter structure.

In some embodiments, when the filter press 300 is operated, the filter structure may be compressed to confine the filtration chamber (FPC), and the silicon slurry 214 may be accommodated within the filtration chamber (FPC). Thereafter, the second filtrate 310 that has passed through the filtration cloth 336 from the silicon slurry 214 may be recovered, and the silicon cake 318 remaining in the filtration chamber (FPC) may be formed.

In some embodiments, the filter press 300 may include a treatment solution supply passage 322 configured to receive the silicon slurry 214 into the filter structure and a filtrate recovery passage 324 configured to discharge the second filtrate 310 from the filter structure. In some embodiments, a portion of the treatment solution supply passage 322 and a portion of the filtrate recovery passage 324 may be formed by compressing the filter structure. For example, each of the filtration plates 332 may include a first through hole, and each of the support frames 334 may include a second through hole. The first through hole and the second through hole may extend through the filtration plate 332 and the support frame 334 in the first horizontal direction (direction X), respectively. For example, when a filter structure is compressed to form the filtration chamber (FPC), the first through hole and the second through hole may be aligned and communicated in the first horizontal direction (direction X), and a plurality of first through holes and a plurality of second through holes may be alternately aligned with each other in the first horizontal direction (direction X) to form a part of the treatment liquid supply passage 322. Similarly, the filtration plates 332 may each include a third through hole spaced apart from the first through hole, and the support frames 334 may each include a fourth through hole spaced apart from the second through hole. When forming the filtration chamber (FPC), the third through hole and the fourth through hole may be aligned and connected in the first horizontal direction (direction X), and the third through holes and the fourth through holes may be alternately aligned with each other in the first horizontal direction (direction X) to form a part of the filtrate recovery passage 324.

In some embodiments, the support frames 334 may each include an inlet port 323 therein, each connecting the treatment solution supply passage 322 and the filtration chamber (FPC). For example, the inlet port 323 may extend through an inner peripheral wall defining an inner space of each of the support frames 334 to be connected to the second through hole of the support frame 334.

In some embodiments, the silicon slurry 214 may be injected into a first end of the treatment solution supply passage 322 to fill the filtration chambers (FPC) with the silicon slurry 214. The silicon slurry 214 may move in the first horizontal direction (X direction) along the treatment solution supply passage 322, and may branch out at each inlet port 323 to fill each filtration chamber (FPC). For example, the silicon slurry 214 may sequentially fill the filtration chambers (FPC) arranged in the first horizontal direction (direction X).

In some embodiments, the silicon slurry 214 inside the filtration chamber (FPC) may be filtered by a hydraulic pressure supplying the silicon slurry 214 to the treatment solution supply passage 322. The silicon slurry 214 inside the filtration chamber (FPC) may be filtered by the filtration cloth 336 by the pressure of the silicon slurry 214 flowing into the filtration chamber (FPC) through the inlet port 323. For example, the second filtrate 310 may be discharged toward two filtration cloths 336 defining the filtration chamber (FPC). In some embodiments, the second filtrate 310 may be received and flowed into a plurality of filtrate channels (not shown) within the filtration plate 332.

In some embodiments, the filtration plates 332 may each include a discharge port 325 therein, each connecting a filtrate channel (not shown) and the filtrate recovery passage 324. For example, the discharge port 325 may be connected to the filtrate channel (not shown) and the third through hole of each filtration plate 332, and the second filtrate 310 may be recovered through the filtrate recovery passage (324).

Although not shown, the filtration plates 332 may further include pressurized water channels (not shown) therein. In some embodiments, the pressurized water may be injected into the pressurized water channel (not shown) to expand the filter plates 332 in the first horizontal direction (direction X) to produce a second filtrate (not shown). For example, even if the filtration plates 332 are expanded, the pressurized water may not be connected to the filtration chamber (FPC). As a result of applying pressure to opposite side walls of the filtration chamber (FPC) along the first horizontal direction (direction X), the second filtrate 310 that passes through the filtration cloth 336 from the silicon slurry 214 may be generated. The second filtrate 310 may be recovered through the filtrate recovery passage 324 as described above. In this case, a plurality of pressurized water channels (not shown) formed within the filtration plates 332 may be spaced apart and separated from the above-described filtrate channel (not shown) and the exhaust port 325.

As described above, by applying pressure to the filtration chamber (FPC), the second filtrate 310 and the silicon cake 318 may be formed from the silicon slurry 214. In some embodiments, a moisture content (wt %) in the silicon cake 318 may be less than that in the silicon slurry 214. For example, the moisture content (wt %) in the silicon cake 318 may range from approximately 0.1 wt % to about 40 wt % of a total weight of the silicon cake 318, but the present disclosure is not limited thereto.

In some embodiments, the pressure cylinder 308 may be reversed to open multiple filtration chambers (FPC), allowing the silicon cake 318 to be dropped into a collector 328. In some embodiments, the filtration plates 332 and the support frames 334 may be connected to each other in a chain of a predetermined length. As the pressure cylinder 308 moves backward, the filter plates 332 and the support frames 334 may be spaced apart from each other in the first horizontal direction (direction X) through the rail 304, and the filtration chambers (FPC) may be opened. In some embodiments, the method of recovering the silicon cake 318 within the filtration chamber (FPC) may include not only a method of recovering the silicon cake 318 by allowing it to fall due to gravity, but also a method of recovering the silicon cake 318 by using air pressure (not shown) on the filtration cloths 336 to detach the silicon cake 318 adhered to the filter cloths 336, or a method of recovering the silicon cake 318 by applying a vibration to the filtration cloths 336 to drop the silicon cake 318. However, the present disclosure is not limited to the examples described above. In some embodiments, a moisture content of a total weight of the silicon cake 318 may be from about 1 wt % to about 40 wt %, or from about 5 wt % to about 35 wt %, but the present disclosure is not limited thereto.

In some embodiments, the filtration cloths 336 may be formed of a multilayer membrane including at least one filtration paper and at least one coating layer. In some embodiments, the filtration membrane may have pore sizes ranging from 100 nm to 1 μm, as well as pore sizes from 1 μm to several thousand μm. In some embodiments, the coating layer may have a smaller pore size than that of the filtration membrane. For example, the filter cloths 336 may be formed of a multilayer membrane that includes a filtration paper and a coating layer, enabling filtration of silicon particles in silicon slurry 214 with very small particle diameters.

In some embodiments, the filtration paper may include at least one of polyimide, polypropylene, polyester, polycarbonate, polyethylene, polypropylene, polyethylene terephthalate, polybutylene terephthalate, polyethylene naphthalate, or polybutylene naphthalate, but the present disclosure is not limited to the examples described above. In some embodiments, the coating layer may include a cellulose-based polymer, but the present disclosure is not limited thereto.

In some embodiments, a portion of the second filtrate 310 may be recycled to an upstream process in the method for recycling silicon in wastewater.

In some embodiments, the second filtrate 310 may include a third filtrate 312 and a fourth filtrate 314, and the third filtrate 312 and the fourth filtrate 314 may each be recycled, either wholly or partially, to the upstream process of the second filtrate 310 (see FIG. 2).

In some embodiments, the third filtrate 312 may be recycled to an operation of forming the silicon slurry 214 from the wastewater 110. In some embodiments, the third filtrate 312 may be circulated to the wastewater tank 100 or included in the wastewater 110 fed to the microfiltration device 200. In some other embodiments, the third filtrate 312 may not be included in the wastewater 110, but may be recovered separately and fed into the microfiltration device 200. For example, a portion of the second filtrate 310 may be recycled to a feed operation of the microfiltration device 200 (see FIG. 2).

In some embodiments, the third filtrate 312 may be recycled to the dielectrophoresis device 120 or incorporated into the wastewater 110 fed into the dielectrophoresis device 120 (see FIG. 2).

In some embodiments, the fourth filtrate 314 may be recycled to the operation (S120) of forming the silicon cake 318 from the silicon slurry 214. For example, all or part of the second filtrate 310 recovered during the process of forming the silicon cake 318 may be recycled to a feed operation of the filter structure of the filter press 300 through the treatment liquid supply passage 322 (see FIG. 2).

In some embodiments, the second filtrate 310 may include a fifth filtrate 316 that is transported to a purification module (not shown). For example, the fifth filtrate 316 may be stored in a buffer tank (not shown) together with the first filtrate 212 recovered through the microfiltration device 200, and subsequently reused as process water after undergoing reverse osmosis and deionization processes (see FIG. 2).

In some embodiments, the second filtrate 310 discharged during the operation of forming the silicon cake 318 may be recovered, with a portion discharged first being recycled to an upstream operation of the process, and another portion discharged later being reused as process water. For example, a portion of the second filtrate 310 discharged earlier in time may be recycled to a feed operation of the microfiltration device 200 or a feed operation of the filter press 300, while a portion discharged later in time may be recovered and reused.

For example, the operation of recovering the second filtrate 310 from the silicon slurry 214 may include recycling the third filtrate 312 and the fourth filtrate 314, followed by recovering the fifth filtrate. The second filtrate 310 may be distinguished based on an order in which it is discharged through the filtrate recovery passage 324 during the operation of compressing the filtration chamber (FCP). For example, the third filtrate 312 and the fourth filtrate 314 of the second filtrate 310 may be discharged during an initial stage of compression, followed by discharge of the fifth filtrate 316. In some embodiments, a silicon particle content (wt %) of the third filtrate 312 may be a first content, and a silicon particle content (wt %) of the fourth filtrate 314 may be a second content. A content (wt %) of silicon particles in the fifth filtrate 316 may be a third content. In some embodiments, the first content and the second content may each be greater than the third content. During an initial operation of the filter press 300, silicon particles having a size that is smaller than the pore size of the filter cloths 336 may be included in and discharged within portions of the third filtrate 312 and the fourth filtrate 314. As compression progresses, the pores of the filtration cloths 336 may become partially blocked by silicon particles or coagulation of silicon particles that are greater than the pores, resulting in the fifth filtrate 316 discharged at a later stage containing silicon particles at a relatively lower content compared to the third filtrate 312 and the fourth filtrate 314. Accordingly, the third filtrate 312 and/or the fourth filtrate 314, which have a relatively high silicon particle content, may be recycled to an upstream operation of the process, where they may be added to the wastewater 110 or the silicon slurry 214, allowing the silicon particles in the third filtrate 312 and/or the fourth filtrate 314 to be repeatedly filtered. Additionally, the fifth filtrate 316 having a relatively low content of silicon particles, i.e., from which silicon particles have been sufficiently removed, may be recovered and reused. In some embodiments, a concentration of silicon particles in the fifth filtrate 316 may be from about 0.1 ppm to about 50 ppm. For example, the concentration of silicon particles in fifth filtrate 316 may be less than about 10 ppm.

In some embodiments, the operation of recovering the second filtrate 310 from the silicon slurry 214 may further include an operation of analyzing the components of the second filtrate 310. In some embodiments, the components of the second filtrate 310 may be analyzed in real time during the process of compressing the silicon slurry 214. A concentration/content of silicon particles in the second filtrate 310 may be analyzed to determine whether the second filtrate 310 should be recycled to an upstream operation of the process or recovered for reuse as process water.

As described above, the content (wt %) of silicon particles in the second filtrate 310 at the initial stage of compression of the silicon slurry 214 may be relatively high, and may decrease depending on the compression process. In some embodiments, the fourth filtrate 314 discharged during the initial pressing may be circulated to the silicon slurry 214 and fed back into the filter press 300. The third filtrate 312, which is discharged thereafter and has a relatively lower silicon particle content (wt %) than that of the fourth filtrate 314, may be circulated to the wastewater 110 and reintroduced into the microfiltration device 200. The fifth filtrate 316 having a lower silicon particle content (wt %) than that of the third filtrate 312 may be recovered as process water after purification.

According to embodiments, the silicon cake 318 may be dried to form the silicon powder 412. The silicon cake 318 may be fed into the fluidized bed reactor 400 and dried under a reducing atmosphere to form the silicon powder 412.

Referring to FIG. 10, according to embodiments, the fluidized bed reactor 400 may include a reactor body 430, a gas injection pipe 434, a dispersion plate 436, a first gas circulation pipe 438, a settling vessel 440, and a second gas circulation pipe 452.

According to embodiments, the silicon cake 318 may be injected from an upper portion of the reactor body 430, and a reducing gas 432 may be injected from a lower portion of the reactor body 430 to fluidize the silicon cake 318 within the reactor body 430. For example, the silicon cake 318 may fall downward due to gravity, while the reducing gas 432 is injected upward from the lower portion, causing the falling silicon cake 318 to be fluidized by an upward airflow.

In some embodiments, the reducing gas 432 may be dispersed into a reaction space within the reactor body 430 through the dispersion plate 436 positioned at the lower portion of the reactor body 430. The reaction space may be defined as a space in which the silicon cake 318 is fluidized. In some embodiments, the reducing gas 432 injected into the reactor body 430 may be uniformly dispersed into the reaction space through the dispersion plate 436. Additionally, the silicon cake 318 or reaction products may fall to a bottom portion of the reactor body 430 without blocking the gas injection pipe 434.

In some embodiments, the reducing gas 432 may include hydrogen (H2). In some embodiments, some of the silicon particles of the silicon cake 318 may have a structure in which a silicon core is coated with a silicon oxide (SiO) layer. The silicon oxide (SiO) layer may undergo a reduction reaction with hydrogen to produce silicon (Si) and water (H2O).

In accordance with the method for recycling silicon in wastewater according to embodiments, silicon particles coated with a silicon oxide (SiO) layer or silicon grains made of a silicon oxide may be reduced to silicon (Si), thereby obtaining silicon (Si) in a pure raw material state.

In some embodiments, the reducing gas 432 may further include an inert gas. In some embodiments, the inert gas may include at least one of argon (Ar), helium (He), nitrogen (N2), neon (Ne), krypton (Kr), or xenon (Xe) In some embodiments, the reactor body 430 may be heated to evaporate moisture in the silicon cake 318 and promote a reduction reaction of the silicon oxide layer. In some embodiments, a temperature inside the reactor body 430 may be maintained at approximately 250° C. to approximately 800° C. In some embodiments, the reducing gas 432 may be injected at a high temperature condition having the temperature range described above.

In some embodiments, the fluidized silicon cake 318 may include silicon clusters and individual silicon particles coagulated by moisture. The individual silicon particles may include a first particle having a relatively small diameter and a second particle having a relatively greater diameter than that of the first particle. For example, the diameter of the first particle may be from about 50 nm to about 250 nm or from about 100 nm to about 200 nm.

In some embodiments, immediately after the silicon cake 318 is fluidized, a content (wt %) of silicon clusters within the fluidized silicon cake 318 may be higher than a content (wt %) of individual silicon particles. Silicon clusters may repeatedly descend by gravity and ascend by the reducing gas 432, and may lose moisture and decompose into individual silicon particles under high temperature and reducing atmosphere. In some embodiments, moisture within the fluidized silicon cake 318 may gradually evaporate, and the first particles, which are relatively light in weight, are blown to an upper portion of the reactor body 430 by a rising air current. The relatively heavier second particles may descend and deposit on an upper surface of the dispersion plate 436, or remain fluidized within the reaction space. In some embodiments, the first particles may flow into the settling vessel 440 through the first gas circulation pipe 438 that connects the reactor body 430 and the settling vessel 440. For example, the first gas circulation pipe 438 may be connected to an upper portion of the reactor body 430 and an upper portion of the settling vessel 440, and the reducing gas 432 and the first particles may be introduced into the settling vessel 440 through the first gas circulation pipe 438.

In some embodiments, the first particles may descend within the settling vessel 440 and settle to a lower portion of the settling vessel 440. Compared to the reactor body 430, there may be no rising air current within the settling vessel 440, or only a relatively small rising air current derived from circulation within the settling vessel 440. The first particles may fall by gravity to be deposited at a lower side of the settling vessel 440 to form the silicon powder 412. In some embodiments, the silicon powder 412 may be formed of the first particles having a relatively small and uniform diameter. For example, among the silicon cake 318 introduced into the fluidized bed reactor 400, a silicon oxide (SiO) may undergo reduction, while the relatively heavier and larger second particles may remain and be separated within the reactor body 430; consequently, the silicon powder 412 recovered from the settling vessel 440 may be formed of uniform-sized, high-purity silicon particles. In accordance with the method for recycling silicon in wastewater according to embodiments, uniform-sized silicon particles may be efficiently recovered using the upward airflow of the reducing gas 432 employed in the process of removing impurities and moisture from the silicon cake 318, without requiring a separate process for classifying silicon particles by size.

In some embodiments, the reducing gas 432 introduced into the settling vessel 440 may circulate back through the second gas circulation pipe 452 to the gas injection pipe 434 for reinjection and reuse in the reactor body 430). In some embodiments, the fluidized bed reactor 400 may further include a dust collection filter 442 provided at the inlet of the gas injection pipe 434 on a side of the settling vessel 440. In some embodiments, the dust collection filter 442 may prevent the second particles, i.e., the silicon powder 412, introduced into the settling vessel 440 from being introduced into the second gas circulation pipe 452 together with the reducing gas 432. That is, the dust collection filter 442 may be configured to filter the silicon powder 412, and the method for recycling silicon in wastewater according to embodiments may reduce a process cost by circulating and reusing the reducing gas 432.

Although not shown, the fluidized bed reactor 400 may further include a moisture removal filter (not shown) provided within the second gas circulation pipe 452. A silicon oxide of the silicon cake 318 may be reduced under a reducing atmosphere to form water (H₂O) may be generated, and the generated water and moisture within the silicon cake 318 may be evaporated within the high-temperature reactor body 430. Accordingly, water vapor may be included in the reducing gas 432 to be introduced into the settling vessel 440. In some embodiments, the water vapor inside the settling vessel 440 may be removed by flowing into the second gas circulation pipe 452 together with the reducing gas 432, and the reducing gas 432 from which the water vapor has been removed may enter the gas injection pipe 434 to be reintroduced into the reactor body 430 in a dry state.

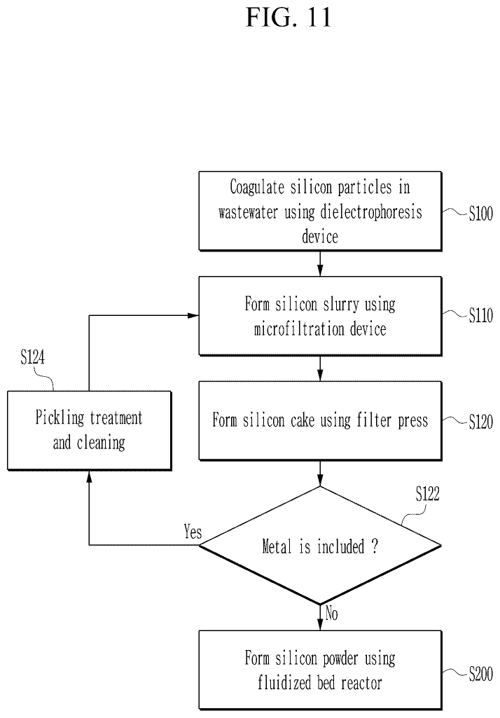

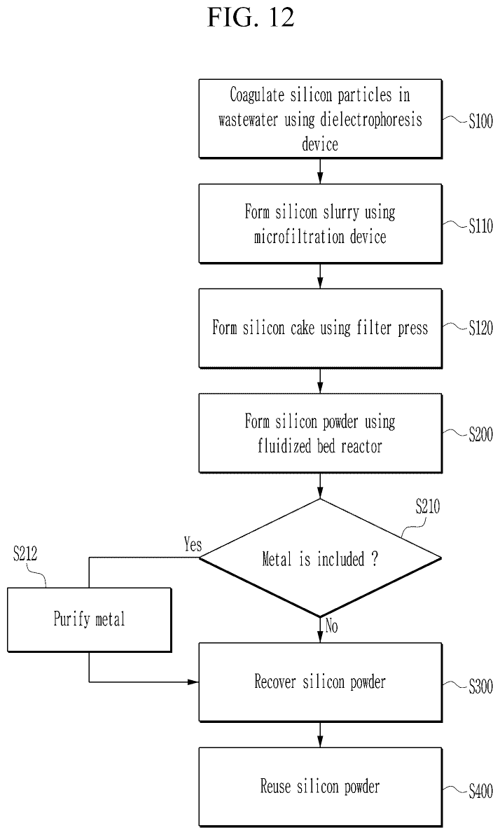

FIG. 11 and FIG. 12 each illustrate a flowchart for describing a method for recycling silicon in wastewater according to various embodiments.

The method for recycling silicon in wastewater described in FIG. 11 will be described with reference to FIGS. 1 to 10, and a redundant description of the described elements and processes will be omitted.

A difference between the method for recycling silicon in wastewater described with reference to FIG. 11 and the method for recycling silicon in wastewater described above with reference to FIG. 5 is whether the method further includes an operation S122 of analyzing whether metal particles are contained in the silicon cake 318 and an operation S124 of removing the metal particles.

In some embodiments, the silicon cake 318 may include metal particles. For example, a semiconductor process that discharges the wastewater 110 includes not only a backside polishing process of a silicon wafer for manufacturing a semiconductor wafer, but also a dicing process, a planarization process, etc. of a semiconductor chip, and accordingly, the wastewater 110, the silicon slurry 214, and the silicon cake 318 may contain metal particles.

According to embodiments, a method for recycling silicon in wastewater may analyze whether metal particles are contained in the silicon cake 318 (S122), and when it is analyzed that metal particles are contained, the metal particles may be removed (S124).

In some embodiments, after forming the silicon cake 318 from the silicon slurry 214, components of the silicon cake 318 may be analyzed to determine whether the silicon cake 318 contains metal particles (S122).

In some other embodiments, presence of metal particles may be determined in a process prior to the operation of manufacturing the silicon cake 318. For example, it may first be determined whether metal particles are contained in the wastewater 110 or the silicon slurry 214. In this case, the removing of the metal particles (S124) may also be performed after forming the silicon cake 318.

In some embodiments, if the analysis indicates that the silicon cake 318 contains metal particles, the metal particles in the silicon cake 318 may be leached and removed using an acidic solution, and the precipitated residue may be washed with water (S124).

In some embodiments, the acid solution may include at least one of a hydrochloric acid (HCl), a nitric acid (HNO₃), a sulfuric acid (H₂SO₄), or a hydrofluoric acid (HF). The silicon cake 318 may be treated with an acid solution to leach out metal particles. The precipitated silicon particles may be recovered and washed repeatedly with water several times to obtain a first mixture including silicon and water, which includes water and silicon particles.

In some embodiments, the first mixture may be recycled to an upstream operation of the silicon recycling process according to embodiments.

For example, silicon particles 121b may be coagulated from silicon particles 121a using the dielectrophoresis device 120, the silicon slurry 214 may be formed from the first mixture using the microfiltration device 200, and the silicon cake 318 may be formed from the silicon slurry 214 using the filter press 300. For example, the first mixture is a solution from which metal particles have been removed, so the silicon cake 318 obtained from the first mixture may not contain metal particles. Thereafter, the silicon cake 318 may be dried under a reducing atmosphere to recover silicon particles having a high purity and uniform size from which metal particles have been removed.

In some other embodiments, when the content of silicon particles in the first mixture is relatively higher than that of the moisture, e.g., when the content of silicon particles in the first mixture is about 2 wt % to about 35 wt % with respect to a total weight of the first mixture, the first mixture may be circulated to the filter press 300 instead of the microfiltration device 200. For example, depending on a concentration/content of the silicon particles in the first mixture, the first mixture may be circulated to an operation of the silicon slurry 214 or the silicon cake 318.

In some embodiments, an analysis may be performed to determine whether the silicon cake 318 contains metal particles (S122), and if the analysis confirms that no metal particles are present in the silicon cake 318 or that they are present below a threshold level, the silicon cake 318 may be dried in a reducing atmosphere to form the silicon powder 412, similar to the method for recycling silicon in wastewater described with reference to FIGS. 1 through 10.

The method for recycling silicon in wastewater described in FIG. 12 will be described with reference to FIGS. 1 to 10, and a redundant description of the described elements and processes will be omitted.

Referring to FIG. 12, a method for recycling silicon in wastewater according to the present disclosure may include an operation S100 of coagulating the silicon particles 121a in the wastewater 110, an operation S200 of forming the silicon powder 412 using the coagulated silicon particles 121b, an operation S210 of analyzing a content of metal particles included in the silicon powder 412, an operation S300 of recovering the silicon powder 412, and an operation S400 of recycling the recovered silicon powder 412.

A difference between the method for recycling silicon in wastewater described with reference to FIG. 12 and the method for recycling silicon in wastewater described above with reference to FIG. 5 is whether the method further includes an operation S210 of analyzing whether metal particles are contained in the silicon powder 412 and an operation S212 of purifying the metal particles.

In the case of the method for recycling silicon in wastewater in FIG. 11, an operation S122 for analyzing whether metal particles are contained in the silicon cake 318 is included, but in FIG. 12, there is a difference in that an operation S210 for analyzing whether metal particles are contained in the silicon powder 412 is included.

In some embodiments, it is analyzed whether metal particles are included in the silicon powder 412 (S210), and if the analysis result confirms that no metal particles exist in the silicon powder 412 or that the metal particles are included in an amount less than a certain reference, the silicon powder 412 may be recycled.

Conversely, if it is confirmed that the concentration of the analyzed metal particles is above a certain reference, an operation of purifying the metal particles from the silicon powder 412 may be further included. The method of purifying the metal particles may include a pickling treatment and cleaning method described in FIG. 11. However, the present disclosure is not limited thereto.

The method for recycling silicon in wastewater described in FIG. 12 may include an operation S400 of recycling the recovered silicon powder 412.

The recovered silicon powder 412 may be used as a raw material for semiconductor wafers, power semiconductors, solar cells, negative electrode substances, etc., but the present disclosure is not limited thereto.

In some embodiments, the silicon powder 412 may be vaporized to form an ingot for manufacturing semiconductor wafers.

For example, a silicon solution manufactured using the silicon powder 412 may be put into a casting mold and rotated to grow a silicon crystal to form an ingot. For example, a Czochralski method (CZ) or a floating zone method (FZ) may be used as a method for growing the silicon crystal.

In some other embodiments, the silicon powder 412 may be carbonized under a reaction gas including a carbon source to form silicon carbide (SIC). For example, the carbon source may include methane CH4. The silicon carbide (SiC) may be used, for example, in the manufacture of SiC power semiconductor wafers.

The manufacturing of SiC power semiconductors may require high-purity silicon (Si), and a cost of SiC wafers may account for approximately 51% of a total cost of SiC power semiconductors. During a growth process of SiC, a quality and supply/demand status of a silicon raw material may have a significant impact on quality and performance of SiC power semiconductors, so it may be necessary to secure silicon (Si) as a domestic raw material for SiC power semiconductors.

In some other embodiments, the silicon powder 412 may be mixed with graphite (C) powder to form a negative electrode material for manufacture of rechargeable batteries. The negative electrode material may include carbonized silicon (SIC), and a rechargeable battery may be manufactured using the negative electrode material.

As demand for batteries, such as electric vehicles (EV), rapidly increases, importance of a silicon (Si)-based negative electrode material is increasing. The silicon (Si)-based negative electrode material may offer the advantage of significantly improving battery performance by providing higher energy density compared to conventional graphite anode materials. In rechargeable batteries, the negative electrode material may account for approximately 15% of a manufacturing cost, but a future shortage of silicon (Si) negative electrode material may lead to instability in the manufacturing of electric vehicles and other products Accordingly, securing silicon (Si) raw material is necessary.

In this way, in accordance with the method for recycling silicon in wastewater according to the present disclosure, the silicon within the semiconductor wastewater 110 may be efficiently recovered using the dielectrophoresis device 120, the microfiltration device 200, the filter press 300, and the fluidized bed reactor 400, thereby improving an efficiency of securing the silicon material. In particular, it incorporates a process for refining metal particles, providing an advantage of securing a high-purity silicon material (Si purity of 11N or higher).

While this disclosure has been described in connection with what is presently considered to be practical embodiments, it is to be understood that the disclosure is not limited to the disclosed embodiments, but, on the contrary, is intended to cover various modifications and equivalent dispositions included within the spirit and scope of the appended claims.

Additionally, the embodiments of the present disclosure are not independent from each other and may be implemented in combination with each other unless there is a particular conflict. Accordingly, embodiments in which embodiments of the present disclosure are combined should also be considered to be included in the present disclosure.

What is claimed is:

1. A method for recycling silicon from wastewater, comprising:
coagulating silicon particles in the wastewater using a dielectrophoresis device;
forming a silicon powder using the coagulated silicon particles; and
recovering the silicon powder.

2. The recycling method of claim 1, wherein the coagulating of the silicon particles includes:
generating an electric field in the wastewater by the dielectrophoresis device;
forming dipoles in the silicon particles in the wastewater; and
coagulating the silicon particles in which the dipoles are formed.

3. The recycling method of claim 1, wherein
the dielectrophoresis device applies a non-uniform electric field.

4. The recycling method of claim 1, wherein
a voltage range applied by the dielectrophoresis device is in a range of 0 to 50 V.

5. The recycling method of claim 1, wherein
a frequency range generated by the dielectrophoresis device is in a range of 0 to 1,000 kHz.

6. The recycling method of claim 1, wherein
a time period for coagulating the silicon particles using the dielectrophoresis device is less than 1 hour.

7. The recycling method of claim 1, wherein
the coagulating of the silicon particles includes
increasing a size of silicon particles contained in the wastewater supplied from a wastewater tank by 100 times or more.

8. The recycling method of claim 1, wherein
the forming of the silicon powder includes
separating the coagulated silicon particles from the wastewater.

9. The recycling method of claim 8, wherein
the separating of the coagulated silicon particles includes
forming a silicon slurry by filtering the coagulated silicon particles from the wastewater using a microfiltration device.

10. The recycling method of claim 9, wherein
the forming of the silicon powder includes
forming a silicon cake from the silicon slurry using a filter press.

11. The recycling method of claim 10, wherein
the forming of the silicon powder includes
forming the silicon powder from the silicon cake using a fluidized bed reactor.

12. A method for recycling silicon from wastewater, comprising:
coagulating silicon particles in the wastewater to a size of 100 nm or greater using a dielectrophoresis device;
forming a silicon slurry from the wastewater using a microfiltration device;
forming a silicon cake from the silicon slurry using a filter press; and
forming the silicon powder by drying a silicon cake using a fluidized bed reactor.

13. The recycling method of claim 12, wherein
the coagulating of the silicon particles includes
using the dielectrophoresis device including a chamber configured to accommodate the wastewater, an electrode positioned in the wastewater, a power supply configured to supply a voltage to the electrode, and a function generator configured to generate a non-uniform electric field by adjusting the voltage supplied from the power supply.

14. The recycling method of claim 12, wherein
the forming of the silicon slurry includes
filtering silicon particles having a size exceeding 100 nm using a microfilter of the microfiltration device, the microfilter having a pore size of 100 nm to 1 μm.

15. The recycling method of claim 12, wherein
the forming of the silicon cake includes
applying pressure to a filtration member of the filter press.

16. The recycling method of claim 12, wherein
the forming of the silicon powder includes
injecting the silicon cake into the fluidized bed reactor and drying the silicon cake with a reducing gas.

17. The recycling method of claim 16, wherein
the reducing gas comprises hydrogen gas (H2).

18. A method for recycling silicon from wastewater, comprising:
coagulating silicon particles in the wastewater;
forming a silicon powder using the coagulated silicon particles;
analyzing a concentration of metal particles contained in the silicon powder;
recovering the silicon powder; and
recycling the recovered silicon powder.

19. The recycling method of claim 18, further comprising
purifying the metal particles from the silicon powder when a content of the analyzed metal particles is above a certain reference.

20. The recycling method of claim 19, further comprising
using the silicon powder as a negative electrode material for manufacturing rechargeable batteries and as a raw material for SiC power semiconductors.
